(19) United States
(12) Patent Application Publication
(10) Pub. No.: US 2002/0143410 A1
(43) Pub. Date: Oct. 3, 2002

(54) Method of controlling a microcomputer after power shutdown

(75) Inventors: Llewellyn Yance, Singapore (SG); Satoshi Endo, Osaka (JP)

Correspondence Address: GREENBLUM & BERNSTEIN, P.L.C., 1941 ROLAND CLARKE PLACE, RESTON, VA, 20191, US

(73) Assignee: MATSUSHITA ELECTRIC INDUSTRIAL CO., Ltd., Osaka (JP)

(21) Appl. No.: 10/025,553

(22) Filed: Dec. 26, 2001

(30) Foreign Application Priority Data
Dec. 27, 2000 (JP) 2000-397543

(51) Int. Cl. G05B 11/01; G05B 19/18; G05B 9/02

(52) U.S. Cl. 700/11; 700/12; 700/2; 700/21; 700/79

(57) ABSTRACT

A method for controlling a microcomputer is provided. The microcomputer is operable without completely expending power of backup power supply when main power is shutdown. During the power shutdown, the microcomputer is connected to a capacitor as a backup power device which supplies small amount of current for a short period. Thus, the microcomputer can execute software for a given period. By changing an operation mode of the microcomputer from high speed mode to low speed mode, power consumption of the microcomputer can be significantly reduced. The method uses software to suppress power consumption of the microcomputer to the minimum and to measure a duration time of power shutdown.

### BACKGROUND OF THE INVENTION

This invention relates to a microcomputer system which employs a limited backup supply resource when power failure of the main power supply occurs, and which retains a content of a backup memory for a certain period of time.

### DESCRIPTION OF THE BACKGROUND ART

A microcomputer system generally employs clock counts (i,e, a real-time clock) to show the current day and time. Such a real-time clock is also used for operations of functions in the system which requires to refer to time information.

However, the system with a real-time clock is prone to be affected easily the accuracy of the real-time clock when a short power interruption (e.g. a momentary power shutdown) occurs. In some systems, when a short power shutdown occurs, the real-time clock is immediately cleared and disabled upon resumption of power. Causes of momentary power shutdowns can range from an accidental unplugging of the system from AC to fluctuations in the AC power line.

This becomes an annoyance to a user since he/she always needs to re-enable and adjust the real time clock every time a short power shutdown occurs.

In order to minimize such annoyance in the use of the real-time clock, whenever power in the system is shutdown and if the shutdown is momentary, the microcomputer of the system should not clear the real-time clock. To achieve such an operation, it is a problem how to determine whether a shutdown of the system power is momentary or not when the shutdown occurs.

One example to solve the problem is that a CR timer is provided to measure how long the microcomputer system is in power shutdown. If the system shutdowns for more than, for example, 3 seconds, the real time clock is cleared and initialized. This is because that the system can avoid excessive time delay brought by stopping the real time clock resulted from a setting to a stop mode of the microcomputer system during power shutdown in which clock oscillation is stopped.

FIG. 4 is a circuit diagram of an arrangement of a conventional hardware-based CR timer. The conventional hardware CR timer includes microcomputer I/O ports 41, a resistor 42, a diode 43, a capacitor 44.

The conventional hardware-based CR timer presents a number of disadvantages. Firstly, high quality, that is, expensive components are required to obtain accurate hardware-based CR timer, since accuracy of the hardware-based CR timer depends on tolerance of the components. Thus, cost of the components add up to the overall material cost of the system. Note that the functional value of this circuit does not justify its cost, since the CR timer circuit is used only for about a few seconds every time the system is shutdown.

Secondly, the number of devices that the microcomputer can directly control are reduced because of a need to allocate a microcomputer I/O port for the CR timer.

### SUMMARY OF THE INVENTION

The present invention overcomes primary disadvantages of the system with the above-mentioned hardware-based timing circuit. Thus it is an object of the present invention to keep a real-time clock in the system updated even after a power shutdown. This system can keep the real-time clock accurately updated with the long-battery backup life even if it stays in power shutdown for a long time. This can be achieved because the method of the present invention uses only software to measure the time spent by the microcomputer during power shutdown.

The microcomputer system of the present invention includes three devices: a counter IC, a microcomputer IC and a clock IC. The microcomputer IC and the clock IC stop their functions when power shutdown occurs. On the other hand, the counter IC continues counting by means of power supplied from a backup battery. When the power is recovered, the microcomputer obtains a count value of the counter IC to update clock counts.

According to the present invention, a method for controlling a microcomputer in microcomputer system with a high speed operation mode and a low speed operation mode in which operations of the microcomputer is slower than in the high speed operation mode is provided. The microcomputer system including a clock operable in the high and the low speed operation mode and a backup power supply for supplying the clock with power for a predetermined time. The method includes steps of: detecting power shutdown; changing the high speed operation mode to the low speed operation mode; determining whether the power shutdown is recovered within a given time period; and setting the high speed operation mode when the power shutdown is determined to be recovered. Thus, the above-mentioned object can be achieved.

As one aspect of the invention, the method includes steps of detecting power shutdown; changing the high speed operation mode to the low speed operation mode; periodically determining whether the power shutdown is recovered within a first given time period; setting the high speed operation mode when the power shutdown is determined to be recovered; and setting the microcomputer to a stop operation mode to stop operations unless the power shutdown is recovered within the second given time period which is longer than the first given time period. Thus, the above-mentioned object can be achieved.

As another aspect of the invention, the method includes steps of detecting power shutdown; checking whether the clock is set; setting the microcomputer to a stop operation mode to stop operations unless the clock is set; changing the high speed operation mode to the low speed operation mode when the clock is set; periodically determining whether the power shutdown is recovered within a first given time period; setting the high speed operation mode when the power shutdown is determined to be recovered; and setting the microcomputer to the stop operation mode unless the power shutdown is recovered within the second given time period which is longer than the first given time period. Accordingly, the above-mentioned object can be achieved.

According to the present invention, microcomputer is supplied with power by a backup capacitor as a backup power supply with small amount of current for a short period during power shutdown of the power supply. Therefore, microcomputer can continue to execute software for a given period. By transferring operation mode of the microcomputer from High Speed Mode to low speed mode, power consumption is significantly reduced. It is further costly advantageous that present invention requires no input/output ports of the microcomputer.

Advantages of the method according to the present invention are as follows: The new method eliminates the need for adding a hardware-based CR timer in the system thereby the overall cost can be brought down. The new method eliminates the need to allocate microcomputer I/O ports once the hardware-based CR timer has been eliminated from the system thereby the system does not need to use the microcomputer I/O ports. Therefore, the present invention is costly advantageous.

The present invention utilizes microcomputer's crystal oscillator as a time reference so that timing accuracy can be consistent.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a timing chart of the operation of a microcomputer according to the present invention.

FIG. 2 is a flowchart of operating sequence of the microcomputer according to the present invention.

FIG. 3 is a diagram of a specific arrangements of signal generation circuit 30 for supplying the AC DET signal and a voltage (VDD).

FIG. 4 is a circuit diagram of an arrangement of a conventional hardware-based CR timer.

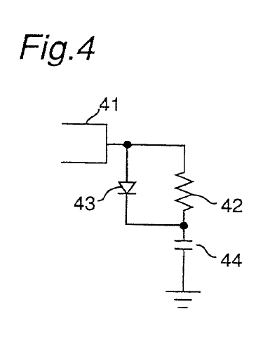

### DETAILED DESCRIPTION OF THE PREFERRED EMBODIMENTS

Some embodiments of the present invention will be described referring to the accompanying drawings. Same functional components are denoted by same numerals throughout the drawings.

CMOS microcomputers consume less power, as operating speed of them becomes slower. For example, power current spec of Mitsubishi 3819 microcomputers is shown in table 1.

TABLE 1

| Operating Condition | Typical | Maximum |
|---|---|---|
| High Speed Mode: | 7.5 mA | 15 mA |
| 8.4 MHz | | |
| Executing Instructions | | |
| Low Speed Mode: | 60 uA | 200 uA |
| 32 KHz | | |
| Executing Instructions | | |
| Low Speed Mode: | 20 uA | 40 uA |
| 32 KHz | | |
| WAIT state | | |
| (wait for INT) | | |
| Stop Mode: | 0.1 uA | 1 uA |
| All Oscillations Stopped | | |
| Waiting for interrupt | | |

M3819 series Power Source Current(Icc)
Taken from page 56, 3819 family user's manual

As seen from the table above, there is a great difference in consumption current of the microcomputer. More specifically, the current consumption of the microcomputer operating at high speed mode is about 100 times as large as that of the microcomputer operating at low speed mode. It can also be seen from the table that there is only a small difference in current consumption when the microcomputer operates in low speed mode or stop mode as compared to high speed mode.

In the present invention, CR timer hardware is not used in a circuit, thus the microcomputer is responsible for measuring how long the system is unplugged. This requires the microcomputer to continue functioning at least about 3 seconds after a power shutdown is detected. Systems with a microcomputer usually employ a 24-hour real-time clock to keep track of the current time in a day.

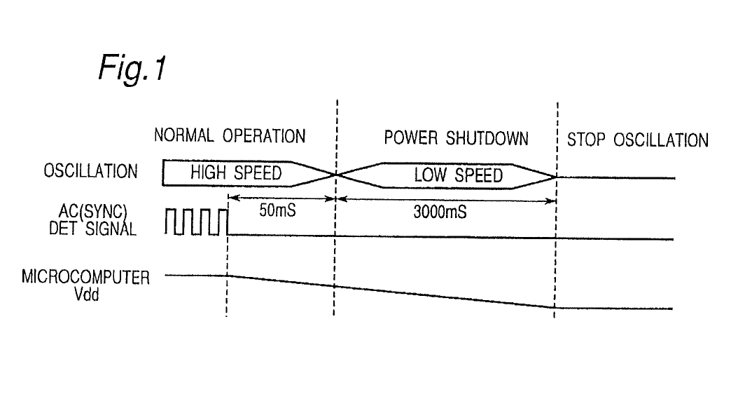

FIG. 1 is a timing chart of the operation of a microcomputer according to the present invention. During normal operation, the microcomputer detects the rising or falling edge of the signal at AC DET as shown in FIG. 1. If no edge is detected for more than 2.5 cycles of 50 Hz (5 OmS), it is confirmed that the AC power supply was removed from the system and a power shutdown sequence must be executed. In other words, the microcomputer in normal operation mode with high speed oscillation transfers to an operation mode at the time of a power shutdown after 50 ms has passed since last edge of an AC DET signal has detected.

In the operation mode at the time of power shutdown, the oscillation is slower than in the normal operation mode. A voltage applied to the microcomputer is gradually lowered after no edge of the AC DET signal has detected. In addition, the microcomputer stops oscillating after 3000 ms (i.e. 3 seconds) has passed since the microcomputer transferred to low speed mode, at the time of which the voltage applied to the microcomputer becomes the lowest.

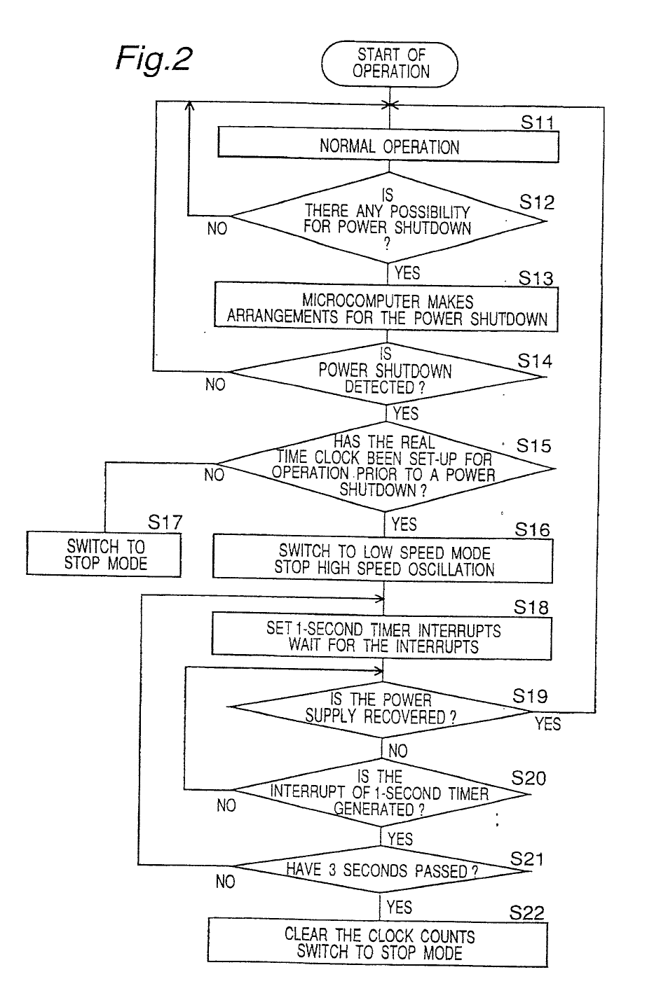

Following are the exemplary sequence of the operation. FIG. 2 is a flowchart of operating sequence of the microcomputer according to the present invention. At the normal operation, the microcomputer operates in high speed mode (step S11). At the same time, whether possibility of power shutdown occurs or not is continuously determined (step S12). In the case that there is no possibility for the power shutdown (i.e. in the case that power shutdown has not occurred), the microcomputer continues normal operation (“NO” in step S12). In the case that the possibility of the power shutdown exists (“YES” in step S12), the microcomputer makes arrangements for the power shutdown (step S13). For example, the arrangements include setting microcomputer I/O ports and de-energizing circumferential circuits against power shutdown.

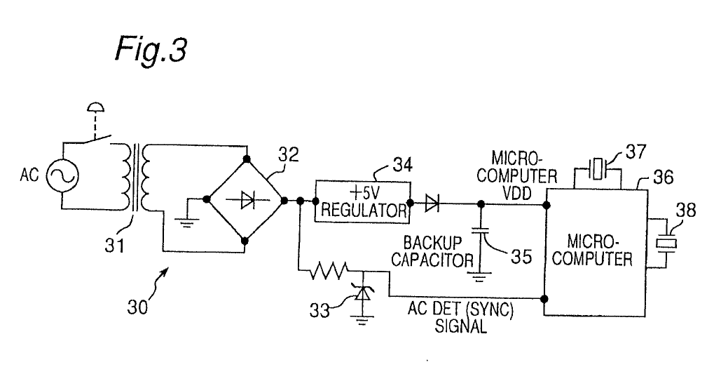

Power Shutdown detection for the microcomputer system is performed by detecting intermittent pulses coming from the AC power line (for example, 50 Hz). Intermittent pulses are detected based on the AC DET signal which is supplied to one input port (AC DET), after rectifying and reducing the amplitude of the power supply line to a predetermined level, thus magnitude of the AC DET signal becomes suitable to input to the microcomputer. A specific arrangement of a circuit for generating the AC DET signal is mentioned later with reference to FIG. 3.

During normal operation, the microcomputer detects a rising or a falling edge of the AC DET signal. If no edge is detected for more than 2.5 cycles of 50 Hz (5 OmS), it is confirmed that the AC power supply is removed from the system and a power shutdown sequence must be executed (“YES” of step S14). If an edge is detected within 5 OmS again, the microcomputer returns to normal operation mode (“NO” of step S14).

In the case that the real time clock has not been set-up for operation prior to a power shutdown (“NO” of step S15), the microcomputer is set to stop mode to set the port for power shutdown (step S17), since processing operations such as counting clocks described later is not needed. According to such operations, time for retaining memory content by a backup capacitor can be extended. However, in the case that the real time clock has been set-up for operation prior to a power shutdown (“YES” of step S15), when power shutdown (AC off) is detected, oscillation of the microcomputer is switched from high speed mode to low speed mode to result in a significant reduction in power consumption (step S16). This means that the microcomputer can still operate by means of supply from the backup capacitor for a short time without completely discharging the backup power.

Once the system is in the low speed mode, an internal timer is set to generate an interrupt in every second (step S18). By executing a WAIT instruction after setting up the 1-second timer, the microcomputer is kept in sleep state while waiting for a 1-second interrupt to be generated. Current consumption of the microcomputer during waiting for the interruption is reduced to be maximum 60 μA. During in WAIT Mode, whether the power supply is recovered or not is monitored (step S19).

When the system power supply is recovered during the microcomputer is waiting for the interruption (“YES” of step S19), the microcomputer quickly changes low speed mode to high speed mode and returns to the normal operation after resetting. On the other hand, when the system power supply is not recovered, whether the 1-second timer generates the interrupt or not is further determined (step S20). When the 1-second timer generates the interrupt, the microcomputer is activated to operate in low speed mode. Note that even if the 1-second timer generates the interrupt, in the case 3 seconds has not passed, the microcomputer is again set to wait for the interrupt from the 1-second timer during the operation to be in WAIT Mode so as to suppress the power consumption of the microcomputer. During WAIT Mode, current consumption is reduced and at the same time, data stored in RAM is never affected as long as power supply voltage (Vdd) of the microcomputer is kept above the rated levels. Note that the system may include one or more volatile memories to hold the time spent by the microcomputer during power shutdown.

When the system power supply has been shutdown yet after 3 seconds passed (step S21), the microcomputer clears the clock counts and transfers to stop mode in the end (step S22). Since all the oscillations are stopped in the stop mode, current from capacitor power supply can be suppressed to the minimum. In such a low power consumption state, data stored in RAM can be retained for more than 2 weeks by means of electricity only left in the backup capacitor. Detection of shutdown time is stopped afterwards.

FIG. 3 is a diagram of a specific arrangements of signal generation circuit 30 for supplying the AC DET signal and a voltage. FIG. 3 also illustrates Microcomputer 36 as well as signal generation circuit 30. The AC DET (SYNC) signal is produced by converting a voltage from AC power supply using a transformer and by adjusting the signal voltage to be constant via rectifier 32 and zener diode 33. The voltage applied to microcomputer 36 which is also referred to as microcomputer Vdd is output after a voltage from AC power supply is converted by using a transformer and adjusted via rectifier 32 and regulator 34.

Backup capacitor 35 is employed to provide microcomputer 36 with small amount of current for a short period during power failure of the power supply. Therefore, in the case the power supply is removed from the system, microcomputer 36 can continue to execute software for a given period. Note that microcomputer 36 includes two types of oscillators: a high speed oscillator 37 and a low speed oscillator 38. High speed oscillator 37 is utilized when microcomputer 36 operates in high speed mode. Low speed oscillator 38 is utilized when microcomputer 36 operates in low speed mode.

In the above description, microcomputer transfers to low speed mode after 5 OmS has passed since last edge of AC DET signal was detected, and transfers to stop mode after 3 seconds has further passed. However, those who skilled in the art may change the above values properly.

The invention being thus described, it will be obvious that the same may be varied in many ways. Such variations are not to be regarded as a departure from the spirit and scope of the invention, and all such modifications as would be obvious to one skilled in the are intended to be included within the scope of the following claims.

The present disclosure relates to subject matter contained in priority Japanese Patent Application No. 2000-397543, filed on Dec. 27, 2000, the contents of which is herein expressly incorporated by reference in its entirety.

What is claimed is:

1. A method for controlling a microcomputer in microcomputer system with a high speed operation mode and a low speed operation mode in which operation speed of the microcomputer is slower than that of the high speed operation mode, said microcomputer system including a clock operable in the high and the low speed operation mode and a backup power supply for supplying the clock with power for a predetermined time, said method comprising steps of:
detecting power shutdown;
changing the high speed operation mode to the low speed operation mode;
determining whether the power shutdown is recovered within a given time period; and
setting the high speed operation mode when the power shutdown is determined to be recovered.

2. The method for controlling a microcomputer according to claim 1, wherein the clock measures the given time period in the low speed operation mode.

3. The method for controlling a microcomputer according to claim 1, further comprises a step of setting the microcomputer to a stop operation mode to stop operations unless the power shutdown is recovered within the given time period.

4. The method for controlling a microcomputer according to claim 1, wherein the microcomputer system further comprises a volatile memory for storing a value representing a time period which the microcomputer measures during power shutdown.

5. A method for controlling a microcomputer in microcomputer system with a high speed operation mode and a low speed operation mode in which operations of the microcomputer is slower than that of the high speed operation mode, said microcomputer system including a clock operable in the high and the low speed operation mode and a backup power supply for supplying the clock with power for a predetermined time, said method comprising steps of:
detecting power shutdown;
changing the high speed operation mode to the low speed operation mode;
periodically determining whether the power shutdown is recovered within a first given time period;
setting the high speed operation mode when the power shutdown is determined to be recovered; and
setting the microcomputer to a stop operation mode to stop operations unless the power shutdown is recovered within the second given time period which is longer than the first given time period.

6. The method for controlling a microcomputer according to claim 5, the second given time period is set to be longer than the first given time period by substantially an integral multiple.

7. The method for controlling a microcomputer according to claim 5, wherein the microcomputer system further comprises a volatile memory for storing a value representing a time period which the microcomputer measures during power shutdown.

8. A method for controlling a microcomputer in microcomputer system with a high speed operation mode and a low speed operation mode in which operations of the microcomputer is slower than that of the high speed operation mode, said microcomputer system including a clock operable in the high and the low speed operation mode and a backup power supply for supplying the clock with power for a predetermined time, said method comprising steps of:
detecting power shutdown;
checking whether the clock is set;
setting the microcomputer to a stop operation mode to stop operations unless the clock is set;
changing the high speed operation mode to the low speed operation mode when the clock is set;
periodically determining whether the power shutdown is recovered within a first given time period;
setting the high speed operation mode when the power shutdown is determined to be recovered; and
setting the microcomputer to the stop operation mode unless the power shutdown is recovered within the second given time period which is longer than the first given time period.

9. The method for controlling a microcomputer according to claim 8, wherein the microcomputer system further comprises a volatile memory for storing a value representing a time period which the microcomputer measures during power shutdown.
